(19) United States
(12) Patent Application Publication
(10) Pub. No.: US 2007/0257920 A1
(43) Pub. Date: Nov. 8, 2007

(54) System and Method for Providing Customized 3D Animations and Fixed Images for Marketing Materials

(76) Inventors: Shawn R. Neider, Pleasant Grove, UT (US); Kelly T. Loesli, Sandy, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/381,944

(22) Filed: May 5, 2006

(51) Int. Cl. G06T 15/70

(52) U.S. Cl. 345/473

(57) ABSTRACT

The present invention is directed to 3D animations and related images which can be customized to selectively insert characters from a database into the 3D animation. The database permits vendors or provider of service who can rely upon the general plot of the 3D animation to promote their goods or services and with the related vendor or provider being a featured character in the 3D animation.

### BACKGROUND OF THE INVENTION

1. Field of the Invention

The present invention relates to the preparation of customized or personalized three-dimensional (3D) computer generated images (CGI) and animations. In particular, the present invention relates to systems and methods for creating and providing customized 3D CGI animation and fixed images for use in marketing materials so as to include likenesses and features of a desired person within the customized 3D animation and fixed content.

2. Background and Related Art

Traditional marketing materials for professionals and others have used fixed images. Some animated materials have been used which show the structure and/or function of goods or services.

Certain types of professionals are subject to historic stereotypes which must be endured or overcome. For example, visits to the doctors for shots or to the dentist are often associated with pain, discomfort or stress. Fixed or animated images used to educate or promote professional services have typically included images of either products or equipment associated with services. Fixed images of pictures of the professionals offering the service have been used, whether they be doctors, dentists, lawyers, plumbers, social workers, contractors, accountants, insurance agents, etc.

While marketing attempts have sought to portray such persons in a favorable light, they have been limited to photographs, drawings, caricatures or other images. Prior marketing images or educational materials have lacked the ability to provide positive, message-based 3D animations customized in the likeness of the individual associated with other 3D images to enhance the image or purpose of the individual in an educational and entertaining way. Billboards, Yellow Page™ advertising, print flyers, mailers, television ads and other print or electronic media have promoted the underlying goods or services using factual information, prior successes or images of the outcome of the service, such as improved appearance after surgery or a wide smile of straight teeth of the benefitee. These images have, however, not sought to use customized 3D animation to portray the professional or individual providing a service as a role model, hero, protagonist or other positive figure solving a common problem associated with such services.

Producing animated, electronic images is very expensive, often costing from hundreds of thousands to millions of dollars for high quality 3D animated images. Such costs put the availability of animated shorts, feature films or other presentations which feature one or more individuals out of the reach of most individuals seeking to promote their reputation, professional image and/or goods or services. What is needed is the ability to provide high quality 3D animated images and other related images customized with the features and likenesses of one or more individuals at a cost competitive to traditional promotional and advertising media.

Thus, while techniques currently exist that are used to create 3D animations and related images, challenges still exist, including customizing them within the direct provider-user relationship or context. Accordingly, it would be an improvement in the art to provide 3D animated products specifically customized to place the service provider and associates in the 3D animated products viewed by the current or potential customer.

### SUMMARY OF THE INVENTION

The present invention relates to providing 3D CGI animated and other related images which include the customized personal likeness and features of one or more intended individuals.

Implementation of the present invention takes place in association with the provider(s) of goods or services, the intended individual(s), and the provider's current or potential customer(s).

The present invention is also directed to featuring the provider(s) in 3D animated short films or a feature length films casting the desired individual as the main character or hero or heroine of the story rescuing the public from the menaces related to the given profession or problem experienced by many. Thus, portraying the intended person as a main character or super hero whose goods or services are not only helpful but needed to prevent the otherwise known ills or problems at hand. A desired individual need not be a main character or hero, but could also be another subject of the film or image.

For example, while going to the doctor for shots or to the dentist, the anxiety associated with pain or discomfort causes many to fear or avoid going to the doctor or dentist. Yet if psychologically, the doctor or dentist can be viewed as a hero saving the day, such fear and avoidance can be at least partially overcome.

The present invention provides one or more methods and products including visual CGI and 3D animated and fixed content customized to include the likeness and features of one or more desired individuals, which individual(s) is/are included as the main character or hero, heroine, or another character in an animated short film or feature length animated films and as well as in related images without the cost of traditional animated products. The present invention permits preparation of short and feature length animated films, the characters of which can be adapted to have the unique and individual likeness and features of an intended person. In this way, substantial portions of the animated content can be used for each customized short or feature length animated films while a smaller portion of the content can be adapted to include the likeness and features of the desired person.

For example, the height, build, race, and other distinguishing characteristics of the person's appearance, behavior or habits can be customized for each short or feature length animated production and associated fixed images. Whether tall, short, dark or light, the individual characteristics of the intended person can be included in the hero figure.

To accomplish this, an animated 3D presentation is created in which the animation features the character to be presented in template or model form. That is, the template or model of the desired individuals functions as a place holder in the animation into which, or in place of which, the holder or new model of the likeness and features of the intended person are inserted or substituted. In other words, the computer or electronic graphics and programming provide images of the general height, build, race, hair color, etc. of the desired individual(s). Furthermore, the template permits the inclusion of the uniquely distinguishing or identifying physical features of the desired individual such as nature or shape of the face, size and placement of eyes, mouth, nose, ears or hair or hairline. The present invention utilizes the creation, storing and retrieving of data or data files from databases or libraries representing the customized likeness and feature of the intended persons to create methods and products uniquely customized to a service provider for use in promoting such services to customer and potential customer. This data or data files are merged with the short or feature length animation or related images to cause the hero to have the likeness and features of the intended person or persons in marketing or educational materials which can be adapted for use by a number of different individuals in a common story offering similar services, or goods to different customers in different locales. This unique method of preparing personalized, customized marketing and educational materials puts the availability of uniquely personalized 3D CGI images in the hands of service providers at a fraction of the cost traditionally associated with 3D CGI animation.

While the methods and processes of the present invention have proven to be particularly useful in the area of preparation of marketing materials for professionals, those skilled in the art can appreciate that the methods and processes can be used in a variety of different applications and in a variety of different areas where the providers of goods or services wants to be depicted in the animations and related images of the marketing materials viewed by an existing or potential customer.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a potential operating system which can be used to create the 3D animations and related images taught by the present invention.

FIG. 3 illustrates a flow diagram of steps of the present invention.

FIG. 4 illustrates a flow diagram of means for incorporating the likeness and features of the intended person as a character in the 3D animated films or images.

### DETAILED DESCRIPTION OF THE INVENTION

It will be readily understood that the components of the present invention, as generally described and illustrated in the figures herein, could be arranged and designed in a wide variety of different configurations. Thus, the following more detailed description of the embodiments of the system and method of the present invention is not intended to limit the scope of the invention, as claimed, but is merely representative of the presently preferred embodiments of the invention.

The present invention relates to systems and methods provide the creation, processing, and production of direct marketing and educational materials including CGI and 3D animated films and other 3D content featuring one or more customized character or hero or heroine having the likeness and features of the intended individual(s).

The following disclosure of the present invention is grouped into subheadings. The utilization of the subheadings is for convenience of the reader only and is not to be construed as limiting in any sense.

### Exemplary Operating Environment

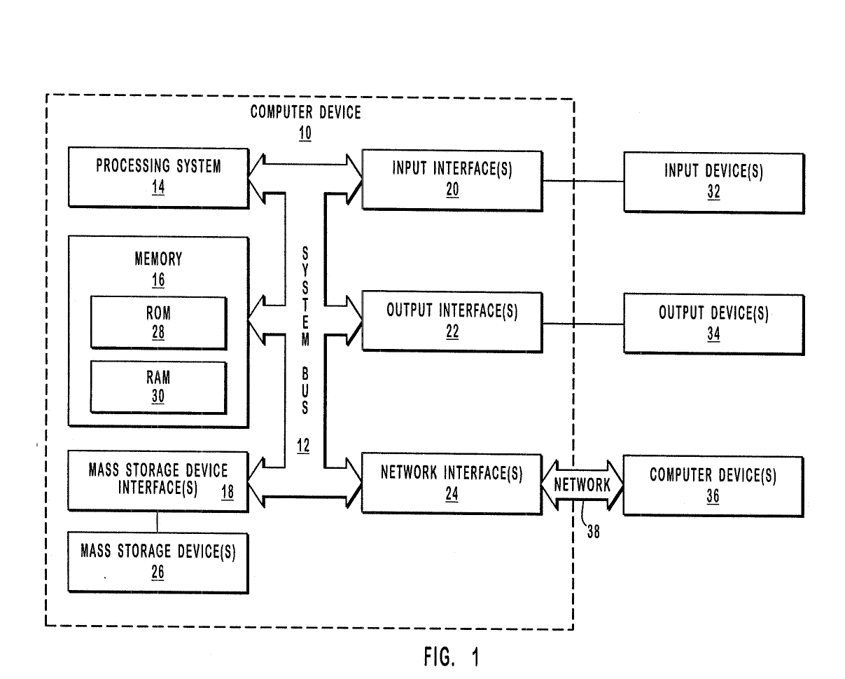

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer.

For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

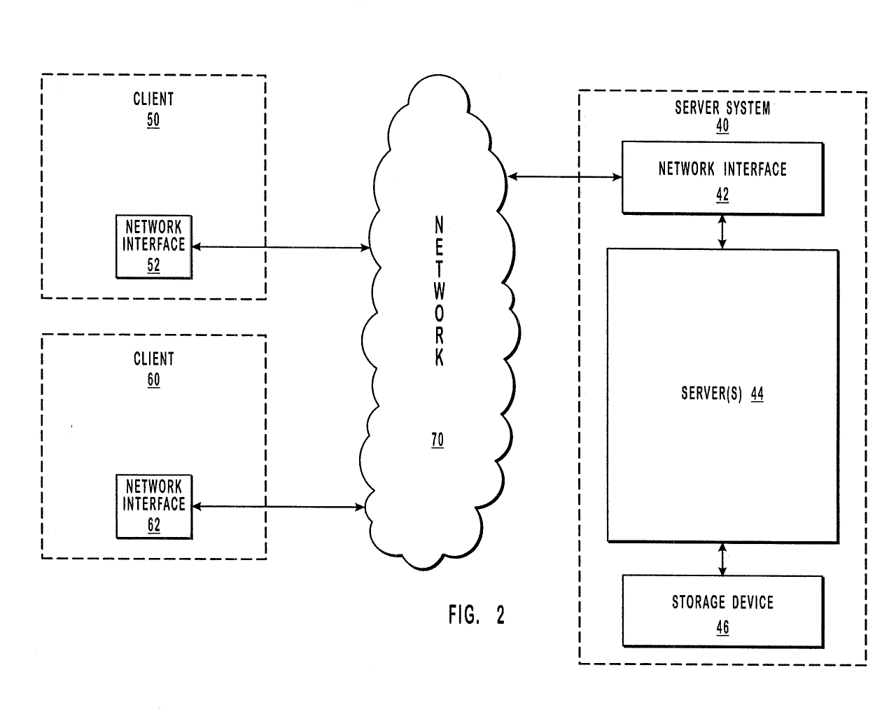

While those skilled in the art will appreciate that the invention may be practiced in networked computing environments with many types of computer system configurations, FIG. 2 represents an embodiment of the present invention in a networked environment that includes clients connected to a server via a network. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

In FIG. 2, a potential network system is depicted by way of example as to a system that could be utilized to achieve the objects of the present invention. Such a system could include a server 40 having a network interface 42, server(s) 44 and one or more storage devices 46. Network 70 operates to integrate server system 42 with client users 50 and 60, each having a network interface 52 and 62.

In general terms, the present systems and methods provide the creation, processing, and production electronic and print media incorporating 3D animated films and other 3D content featuring a customized character or hero or heroine having the unique likeness and practical features of the intended individual(s).

Such films and related fixed images may be distributed via the Internet, CD-ROM, DVD, electronic file transfer, print media, as 3D action figures, images on products or wearing apparel.

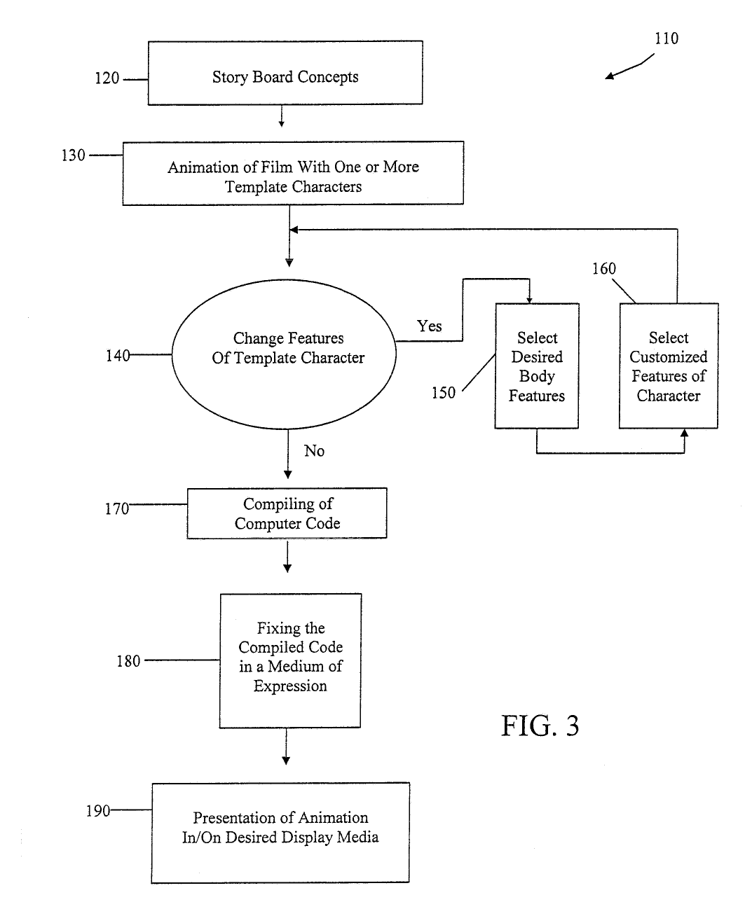

As depicted in FIG. 3, in one embodiment of the present system 110, a creator of the subject 3D film or depiction need not recreate or re-render the entire 3D film or depiction in a separate production process for each 3D animation featuring an intended character or hero or heroine. Rather, the present system allows a story to be developed with a main character or hero, as well as secondary characters or counterparts such as sidekicks, villains, others and the like. The creator creates a story board 120 to outline the plot and provides some concepts for 3D image generation.

After creation of a story board, one or more animators transform the concepts of the story board into an animation 130. Some animations are only a few minutes. Other animations are full feature length films. As the animation or related fixed images are being prepared, the environment and one or more characters such as a hero, heroine, villain or another are created using known animation techniques, equipment and processes.

However, unlike the prior art and educational materials, one or more characters are animated such that the nature, colors, sizes, shapes and other distinguishing features of the character's likeness, appearance or behavior may be selectively changed. This can be done by preparing the animation such that one or more characters are in template form 130 such that they can be changed or replaced. Such change or selection of character features can be from databases or libraries 150 and 160 of the desired features, including one or more features individually unique to the intended person who is to be portrayed as a character in the animation or related images.

After the attributes of the desired character(s) are selected, the attributes are merged with the rest of the animation code. The computer code is compiled 170 and fixed in some electronic or mechanical medium 180. Thereafter, the animation or image is presented visually for the viewer 190.

The animation 120 uses equipment, programs and techniques known to those skilled in the art. For example, 3D modeling, animation and motion capture computer programs such as Maya, Cinema 4D, 3D Studio Max, SoftImage, MotionBuilder and various other similar programs can be used, as well as various Avid, Adobe and Apple programs for digital editing, compositing and visual effects can be used. Use of rendering servers was used. Using this software and related equipment, one is able to animate the story board.

One feature of the animation is the creation of one or more template or model characters 130. Template characters can be changed, or, act as place holders for the input of features of the characters. Features for the template character may be initially selected during animation 130.

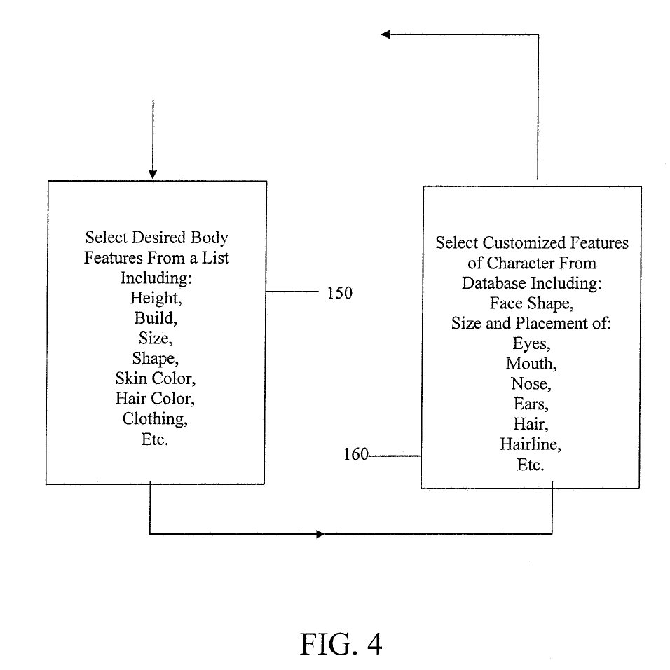

Otherwise, if it is desired to change or substitute the features of one or more template characters 140, files in or databases and/or libraries 150 and 160 containing character features can be accessed to obtain the desired features. As illustrated in FIGS. 3 and 4, features of a desired animated character can include general height, weight, build, size, shape, skin color, hair color, professional or trade clothing or uniform, and the like. More distinguishing features may include the particular nature, shape, size or placement of eyes, mouth, nose, ears, hair, hairline and other visual features unique to a particular individual. Such feature information can be readily saved as data representing character appearance features in and accessed from work files, databases or libraries. This selection, access and retrieval of data is means for incorporating the electronic appearance data of one or more characters, suppliers or vendors as the features of one or more template characters in the 3D animation.

After character features have been selected, the computer animation code is compiled using known equipment, techniques and processes to make the code executable 170. Executable code is then fixed, saved or burned into a mechanical or electronic medium 180. Media 180 includes interactive Internet websites, CD-ROM, DVD and other data information storage devices.

The executable codes are then used to present, render, or display customized animation or related images in or on display media such as a computer or television screen or monitor, through a projector onto a screen or wall, or reduced to print media 190. Display media 190 can include short animated films, interactive Internet page, business cards, letterhead and envelopes, computer desktop wallpaper, DVDs for viewing on DVD players, posters, life-size posters, post cards, interactive computer games, interactive screen savers, E-cards, coloring books, appointment cards and check-up reminders, good check-up certificates, action figures, toys, wrist bands, wall décor, flyers and brochures, products such as toothpaste, toothbrushes, floss, adhesive bandages, tongue depressors, ear, nose or throat scopes, cups, tools, bandages, stickers, apparel or any other article used by the featured individual(s) or used to promote the featured individual's goods or services. Display media 190 are means for displaying the 3D animation.

The practice of this invention permits a vendor/supplier of goods or services to insert his own individual likeness or image into a 3D animation, the cost of which is shared by a number of vendors/suppliers who can utilize a similar story. By utilizing means for incorporating the data representing character features of a plurality of characters as the features of one or more template characters in the 3D animation, the intended vendor/supplier of goods or services can be uniquely featured as a character in the 3D animation. No known prior art marketing or educational materials provide this value. In other words, the present invention provides 3D animation marketing and educational materials uniquely customized to a particular provider-user relationship: the user or viewer is provided 3D animation marketing or educational materials from the provider or vendor of goods or services with the provider being featured in the 3D animation viewed by the user, customer or potential customer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method of depicting a provider of goods or services in animated CGI or 3D films, the method comprising:
processing data to create 3D animation;
preparing one or more template characters of the 3D animation whose appearance features can be selectively changed or substituted;
providing electronic data representing appearance features of a plurality of providers;
selectively incorporating the electronic appearance data of one or more providers as the features of one or more of the template characters in the 3D animation; and
rendering the 3D animation.

2. The method of claim 1 wherein one or more template characters are depicted in the 3D animation as a hero.

3. In a computer system for creating customized 3D animations for marketing or educational materials, suppliers of goods or services, the system comprising:
means for processing data to create 3D animation;
means for preparing one or more template characters of the 3D animation whose features can be selectively changed or substituted;
electronic data representing character features of a plurality of suppliers;
means for selectively incorporating the electronic appearance data of one or more suppliers as the features of one or more template characters in the 3D animation; and
means for rendering the 3D animation.

4. The method of claim 3 wherein one or more template characters are depicted in the 3D animation as a hero.

5. A computer program product for implementing within a computer system a method for customizing marketing or educational materials, the computer program product comprising:
a computer readable medium for providing computer program code means utilized to implement the method, wherein the computer program code means is comprised of executable code for implementing the steps for:
processing data to create 3D animation;
preparing one or more template characters of the 3D animation whose appearance features can be selectively changed or substituted;
providing electronic data representing appearance features of a plurality of providers;
selectively incorporating the electronic appearance data of one or more providers as the features of one or more of the template characters in the 3D animation; and
rendering the 3D animation.

6. The method of claim 5 wherein one or more template characters are depicted in the 3D animation as a hero.

7. Customized 3D animated educational materials of the provider of goods or services depicting the provider of the goods or services, and to be viewed by a customer or potential customer of the provider, the materials comprising:
a 3D animated story common to a plurality of providers; and
one or more providers selectively depicted in the 3D animated story from a database of features representing a plurality of providers.

8. The method of claim 7 wherein one or more template characters are depicted in the 3D animation as a hero.
